(19) United States
(12) Patent Application Publication
(10) Pub. No.: US 2023/0014928 A1
(43) Pub. Date: Jan. 19, 2023

(54) ELECTRONIC-SPORTS MOBILE TOURNAMENT STREAMING PLATFORM

(71) Applicant: SE GAMING SERVICES INC, Middletown, DE (US)

(72) Inventors: Krystal Yang, San Juan, PR (US); Tony Chen, San Juan, PR (US)

(21) Appl. No.: 17/863,870

(22) Filed: Jul. 13, 2022

Related U.S. Application Data
(60) Provisional application No. 63/221,715, filed on Jul. 14, 2021.

(51) Int. Cl. A63F 13/792; A63F 13/71

(52) U.S. Cl. CPC A63F 13/792; A63F 13/71

(57) ABSTRACT

The disclosed system provides a novel framework for organizing, hosting and/or providing capabilities for an online, mobile esports gaming environment. In some embodiments, the disclosed framework supports tokenization and nonfungible tokens (NFTs), and can operate in connection with a Blockchain (or similar distributed ledger technology). In some embodiments, the disclosed framework provides a live-streaming, secure, cryptocurrency-enabled and backed gaming environment. In some embodiments, the disclosed framework provides an electronic tournament experience via an organization and streaming platform that enables gamers to accurately and efficiently organize mobile game tournaments that pay out real prizes in any currency (e.g., crypto or fiat). In some embodiments, the disclosed framework can be configured and built as a mobile computing environment, and/or with mobile functionality that enables an optimized mobile gaming experience.

### CROSS-REFERENCE TO RELATED APPLICATION

This application claims the benefit and priority to U.S. Provisional Application No. 63/221,715, filed Jul. 14, 2021, the entire contents of which are incorporated herein by reference.

### FIELD

The present disclosure relates generally to improving the performance of network-based computerized content hosting and providing devices, systems, and/or platforms by modifying the capabilities and providing non-native functionality to such devices, systems and/or platforms through an improved framework for an electronic-sports (esports) mobile tournament streaming platform.

### BACKGROUND

Mobile gaming is currently the most popular form of electronic gaming in the world. Current trends show that there is a 13.3% rate of increase of mobile gamers yearly. Indeed, there are currently over 2.6 billion mobile gamers, where 92 million of which entered the gaming ecosystem in 2020 alone. And, between 2018-2019, the mobile esports industry realized a viewership jump from 15.3 million to 98.5 million hours, which is an increase of more than 600% in one year. Accordingly, mobile esports is revolutionizing online gaming.

Despite the rise of mobile gaming, however, there are very few esports tournaments for mobile games. With the exception of some mobile games (e.g., Clash of Clans®), mobile games are significantly underrepresented in esports tournaments. There is currently no mobile platform that allows gamers (or users or competitors, used interchangeably) to organize and host their own tournaments. The only mobile tournament platform that currently exists only supports a limited number of pre-selected, organizer-set games in low growth categories, and requires direct integration with the game developer(s). Moreover, competitive mobile gamers are currently unable to compete in their games of choice and build fanbases through game streaming. Such fanbase building through game streaming is increasingly financially lucrative.

Conventional esports tournament platforms have technological and foundational limitations that prevent expansion, adaptability, customization and transactional execution that the current ecosystem requires. For example, existing tournament organization platforms are not optimized for mobile, as they are only configured for personal computers (PCs) or restricted to existing gaming consoles. As mentioned above, the only current tournament platform does not provide organizational or structural capability for everyday users. Currently, prize pools are only provided in a dollar format such as the United States (US) dollar (USD). This creates unfair payouts due to currency conversion costs, and also renders payments late, delayed or even incapable of being processed because they are dependent upon a financial institution's availability and/or ability to process the payout (e.g., payout can take up to 4-6 weeks). Also, the potential for chargebacks is high, therefore causing a risk to company revenue.

Moreover, such conventional systems lack native streaming functionality, as well as universally native chat and social functionality. There is no current tournament platform that enables live-streaming along with real-time chat and social functionality from a single application or platform, as is disclosed herein. Additionally, conventional systems do not provide the ability to share ad revenue with users or publishers.

In addition to the above shortcomings, conventional systems are not backed by, nor are they supported by current cryptographic functionalities that can provide a secure, streamlined, computationally efficient gaming environment as provided by the disclosed framework.

### SUMMARY

Some embodiments of the disclosed systems and methods provided by the disclosed framework support tokenization and nonfungible tokens (NFTs) and can operate in connection with a Blockchain (or similar distributed ledger technology). Existing systems lack this functionality, and therefore, are unable to provide the live-streaming, secure, cryptocurrency enabled and backed gaming environment that some embodiments of the instant disclosure are capable of and configured to provide.

Thus, some embodiments provide an electronic tournament experience via an organizational streaming platform (referred to as a tournament platform framework) that enables gamers to accurately and efficiently organize mobile game tournaments that pay out real prizes in any currency (e.g., crypto or fiat). According to some embodiments, the disclosed framework can be configured and built as a mobile computing environment, and/or with mobile functionality that enables an optimized mobile gaming experience.

Some embodiments enable the framework to provide gamers with functionality and electronic tools to organize, host and control a tournament of other gamers. According to some embodiments, the system is configured to enable gamers, via their smartphones or other mobile devices (e.g., tablets), for example, to schedule private, unlisted or public tournaments via a computerized application associated with the disclosed system framework (“app” or mobile app, used interchangeably). In some embodiments, the app is configured to enable gamers or other users (e.g., individuals, devices and/or publishers) to implement the app's software development kit (SDK) to construct one or more of a tournament for a specific game, for a specific time period, for a set of gamers and an allocated prize pool, and the like. In some embodiments, the mobile app is configured to either run as an overlay above a mobile game or in the background (as discussed below in relation to at least FIGS. 3-4B. Since the app can operate as an overlay or execute in the background, in some embodiments, the app does not require a game publisher to natively integrate with the game. Some embodiments of the app are compatible and/or configurable to operate with any game on any platform (e.g., PC, Mac, cellular phone, and/or mobile computer) and accept and enable any quantity and/or type of gamer. In some embodiments, the system supports access from any type of computer, where gamers using different types of computers can each access the same game at the same time.

According to some embodiments, as discussed in more detail below, the disclosed framework is configured with live-streaming (e.g., Hypertext Transfer Protocol (HTTP) Live Streaming (HLS), for example) capabilities, as well as live-chat and social networking integration and functionality. According to some embodiments, each individual competitor's screen can be streamed live over the platform (herein referred to as a “stream”). In some embodiments, the system is configured to provide organizers with the ability to select which gamer (or competitor) stream is displayed on the master tournament stream, which can also be shared via uniform resource locator (URL) or integrated with another application/platform (e.g., Twitch® or YouTube®). In some embodiments, viewers watching can be provided functionality (e.g., via the app) to flip or toggle between the master screen or individual competitor screens as they watch the matches and engage with other fans via a live chat. In some embodiments, registered users (e.g., organizers, competitors and/or viewers) are provided with permissions to chat. In some embodiments, the system is configured to provide individual users the option to cross stream their own individual screen or the master screen to their personal streaming platforms.

In some embodiments, the disclosed framework may be configured with smart contract functionality to allow users to stake cryptocurrency in an escrow wallet or staking node with one another using a probability or betting ruleset for specific tournament match outcomes. In some embodiments, match outcomes may be determined based on specific conditions (e.g., win/loss ratio, points earned, kill/death, etc.)

In some embodiments, the disclosed framework can be configured with functionality for providing a leaderboard. In some embodiments, the leaderboard can be an interface, sub-window or overlay, pop-up dialog box. In some embodiments, the leaderboard can be for one or more of a specific set of games, a tournament(s), a specific game, region, and the like. In some embodiments, the leaderboard can be aggregated across all games, and/or according to a specified criteria (e.g., a leaderboard for particularly ranked or located users, a leaderboard for a specific game, and the like, or some combination thereof). In some embodiments, the leaderboard can be adjudicated on a time period basis using specific win/loss conditions during one or more of monthly, quarterly, or annual periods, and follow each gamer's unique gamer tag. In some embodiments, once awarded to the gamer, the system is configured to enable Gamer Tokens to be sold, traded, gifted, or held, with monetary value. In some embodiments, the leaderboard functionality can employ a unique combinatorial calculation methodology to determine leadership, for example, at the individual game title level. In some embodiments, the leadership can be determined at a global gaming level (or any other type of predetermined level). According to some embodiments, any type of known or to be known, calculation methodologies can be employed to ensure equity across the competitive gaming space.

In some embodiments, the system is configured to enable matches to be adjudicated by the tournament organizer to select a winner. In some embodiments, the system is configured to enable the results of the matches and/or adjudications to be validated via on-chain consensus voting by one or more users. In some embodiments, the system framework is configured to update one or more blockchains with winning data after a winner has been selected and/or a majority confirmation from the voting has occurred. In some embodiments, if only a minority agree, the tournament organizer will be notified by the system and given the choice between recasting the vote or opening a dispute. In some embodiments, matches will be adjudicated via automated match adjudication using either on-chain data validation or an oracle to offer a fully trustless, decentralized tournament adjudication and payout process.

In some embodiments, the disclosed framework is configured with functionality for supporting multiple fiat currencies and multiple currency exchanges/platforms. Some embodiments configure the disclosed framework to provide immediate payouts based on blockchain technologies, whereby leveraging such a distributed, immutable trustless ledger reduces chargeback potential. In some embodiments, prizes, awards and/or gaming information can be controlled and provided via proprietary tokens specific to the mobile app/framework (discussed below), cryptocurrencies and/or NFTs.

According to some embodiments, the disclosed framework can be configured with a robust payment system built using blockchain technology that facilitates both cryptocurrency and fiat transactions. In some embodiments, all entry fees (e.g., crypto/fiat) can be converted to a digital or electronic token specific to the app (e.g., referred to as an “Ignite” or “TENKA®” token in some embodiments). The token, which in some embodiments is a deflationary multipurpose utility token, enables one or more of engagement in a tournament, verification of results within the tournament, and reception of prizes, and/or ad revenue sharing, as discussed below. In some embodiments, the token can be configured to be tightly coupled to and/or directly associated with the disclosed framework (e.g., is proprietary to the disclosed tournament platform). According to some embodiments, the token can be associated with a Stablecoin (e.g., DAI or USDT). It should be understood that while the discussion herein will focus on Ignite or TENKA® as the token, it should not be construed as limiting, as any type or range of known or to be known cryptocurrencies can be utilized to determine a market's value without departing from the scope of the instant disclosure, nor it will it be construed as limiting the token to only Ignite/TENKA® token. In some embodiments, the token can be utilized as a primary access and spending vehicle within a tournament, a tournament platform and/or within the tournament mobile application. For example, users can use the token to pay for entry fees, prizing, and the like. In some embodiments, the token can be utilized to process transaction fees.

In some embodiments, the system is configured to enable a token(s) to be purchased by a user using other cryptocurrencies or with fiat. In some embodiments, such purchase can involve the generation of a token based on the current market value of the cryptocurrency or fiat used to purchase the fiat. In some embodiments, as discussed below, the purchased token can be stored in association with a wallet of the user and/or a tournament for which it can be utilized.

In some embodiments, the system is configured to enable tokens to be traded and/or converted back into another cryptocurrency or fiat. In some embodiments, the trade or conversion of a token need not be to the original cryptocurrency or fiat that was used to purchase the token. In some embodiments, the trade or conversion can be based on current market prices or values of other cryptocurrencies or fiat.

In some embodiments, prizes, payouts and/or other results-based rewards for a tournament can be provided to users in the form of the token or its associated Stablecoin. In some embodiments, the received, earned and/or rewarded tokens can be exchanged for other cryptocurrency or fiat.

In some embodiments, the disclosed framework can be configured with functionality for directly converting a token to another cryptocurrency or fiat. In some embodiments, the disclosed framework includes capabilities that enable users to buy, sell, transfer and store digital currency. In some embodiments, the disclosed framework can operate as an augmenting script, smart contract, overlay or companion application to another secure online platform for buying, selling, transferring and/or storing digital currency.

In some embodiments, as discussed below, the token can be configured to be leveraged for operating as an oracle to pull (e.g., extract and/or retrieve) data from games and tournaments directly integrated and/or hosted by the framework's platform. In some embodiments, the token can be utilized to automate match results and execute payouts via a specifically applied escrow protocol (e.g., referred to as, for example, TENKA® token escrow protocol), as discussed below. In some embodiments, the escrow protocol can provide an on-chain staking mechanism via a dynamic smart contract system. In some embodiments, the escrow wallet or staking node is stabilized by a Stablecoin (e.g., DAI).

In some embodiments, the disclosed token can operate as a governance token. In some embodiments, the token can provide voting rights to holders who wish to vote on a rewards allocation, risk management, network upgrades, treasury management, council membership elections, slashing rates, and the like. In some embodiments, the token's voting powers may provide holders with the power to participate in and vote on proposals in a Decentralized Autonomous Organization (DAO).

In some embodiments, the disclosed token can provide network utility. In some embodiments, the token can be configured as a native fee token for native transactions, smart contracts, escrow functions and transactions (e.g., entry fees, prizes, rewards, and the like), oracle functions, NFT features, staking escrow pools, game reward tokens (e.g., a limited pool of tokens existing only on the TENKA® token network awarded to a top n % of gamers on a platforms, which can be based on a user's popularity, rating, results, followers and the like), and the like.

In some embodiments, gamer reward tokens (e.g., also referred to as Gamer Tokens) may be rewarded to users and traded on the tournament platform. Gamer Tokens are a limited pool of tokens existing only on the Ignite/TENKA® token network awarded to a top n % of gamers on a platform, which can be based on one or more of a user's popularity, rating, results, followers and the like. In some embodiments, Gamer Tokens may be issued as fungible or non-fungible tokens. In some embodiments, Gamer Tokens can be traded for Ignite/TENKA® token or other Gamer Tokens. In some embodiments, Gamer Tokens can operate in a similar manner as the Ignite or TENKA® token; however, in some embodiments, Gamer Tokens cannot be traded outside of the Ignite Tournaments platform or outside the Ignite/TENKA® token network. In some embodiments, a percentage of Gamer Tokens may be held in the Ignite/TENKA® token Treasury and can also be staked on-chain in the escrow wallet or staking node as part of the prize pool. In some embodiments, Gamer Tokens can also be rewarded to tournament winners as a prize. In some embodiments, once awarded to the gamer, the Gamer Tokens are permitted to be sold, traded, gifted, or held, with monetary value. In some embodiments, Gamer Tokens can interact with NFTs.

In some embodiments, the Ignite/TENKA® token can be configured to operate in parallel with existing deflationary models and farming/mining protocols. In some embodiments, the token can be a deflationary token that has a finite (or capped) supply which will appreciate in value as more tokens are mined.

In some embodiments, the Ignite/TENKA® token can be farmed throughout the duration of the tournament via Proof-of-Stake, generating yield via staked tokens in validator/escrow nodes. In some embodiments, the Ignite/TENKA® token can be farmed via liquidity pools using existing deflationary models for yield farming. In some embodiments, farmed tokens can be rewarded to gamers as rewards after tournaments. In some embodiments, farmed tokens can be rewarded as yield to validators and liquidity providers. FIG. 9 shows a TENKA® token overview according to some embodiments.

In some embodiments, there can be a capped supply of tokens (for example, 1B tokens). In some embodiments, a portion of tokens (e.g., 150M-200M tokens (15%-20%)) can be leveraged from the overall token pool to support farming and fund initial development. In some embodiments, new TENKA® can be farmed periodically (e.g., via participation every 10 minutes). In some embodiments, such farming can (a) parallel existing crypto-protocol (e.g., the Bitcoin protocol), and can (b) incentivize gamers, stakers, and validators/collators, and the like. In some embodiments, tokens can be distributed immediately after farming according to an alterable, predetermined allocation. In some embodiments, the allocation can be based on group consensus via the TENKA® token governance protocol.

An illustrative, non-limiting example is: 70% to pay out bonuses to winners of the 10 most popular tournaments which ended in the last 10 minutes OR to pay out a bonus to a single tournament winner chosen to be the “grand winner” over the last 10 minutes; 10% to the Most Valuable Player (MVP) at the time the block is farmed OR 10% to the MVP over the last 10 minutes; 10% to the treasury; 5% to validators/collators; and 5% to stakers. In some embodiments, a percentage (e.g., 20%) of the remaining supply of unmined tokens can be farmed according to time period on a time-based farming mechanism; for example, every six months and/or 36% annually)

An illustrative, non-limiting, example is: if 200M tokens are mined, then 800M remain to be mined. If 160M are farmed over the current six month period, then ˜26,000 blocks will be farmed in this time, and ˜6,000 TENKA® tokens will be farmed per block (at present). For example: the market cap of all TENKA® tokens at $200M implies a token value of $0.20 per TENKA token. With 1,000 ongoing tournaments, average tournament duration 50 minutes, approximately 200 tournaments ending every 10 minutes. For example, the financial implications can be as follows: 3,000 TENKA® valued at $600 gets paid out to either 10 gamers ($60 reward/gamer) or 1 gamer ($600 reward to one gamer); this structure will reward the gamer to encourage more competitive play; 600 TENKA® valued at $120 paid out to the MVP—this becomes either an additional incentive to the top winner or to another gamer who happened to be MVP at the time of the block farming (MVP can be defined however the community decides), in the second case this encourages gamers to perform outstandingly every 10 minutes, as this could mean a reward of $120 just for performing well in a given moment.

According to some embodiments, the above mechanism has an implied supply/demand incentive for adoption of tournaments on the Ignite Tournaments platform, so that gamers benefit massively when there are a lower volume of tournaments ongoing. Due to its deflationary nature, the relative value of each TENKA® token will increase in a similar manner as Bitcoin.

In some embodiments, the following fees can be stored in the TENKA® Treasury and may be under the governance of TENKA® holders: a predetermined or dynamically determined portion or percentage (e.g., 10%) of all entry fees for tournaments can be set aside in the Treasury; network fees can include, but are not limited to, native transaction fees, escrow management fees, general network transaction fees, cross-chain operability fees, and the like; exchange fees for swapping between TENKA®, TENKD, and gamer tokens; exchange fees between TENKA®/TENKD and other cryptocurrencies such as DOT, KSM, BTC, ETH, and the like; and exchange fees for swapping from fiat into TENKA® tokens; independent validators on the TENKA® network that show harmful behavior such as going offline, attacking the network, or other malicious activity will have a percentage of all bonded/staked tokens slashed. When users buy gamer tokens, the proceeds will be held in the Treasury. A percentage of gamer tokens will also be held in the Treasury.

In some embodiments, in addition to supporting escrow functionality (e.g., buying TENKA the moment it is staked in exchange for TENKD), funds held in the Treasury can be spent based on group consensus by the TENKA® Council. Spending proposals may include, but are not limited to, the following categories: ecosystem development and operation, network security maintenance and development, marketing, community development and outreach, sponsored tournaments and events, and grants, and the like, or some combination thereof.

According to some embodiments, prize pools can be staked on-chain or stored in unique escrow digital wallets for each individual tournament. In some embodiments, the wallets can act as an agent for the user and serve as a connection to a specific account portion for the user within the blockchain. In some embodiments, the digital wallet can be stored and/or accessible on the user's device (e.g., smartphone), and in some embodiments, the wallet can be housed in the cloud.

In some embodiments, an individual digital wallet will be generated for each user. In some embodiments, users can use the wallets to send or receive cryptocurrency both internally on the platform and externally to and from users outside of the platform. In some embodiments, this wallet may be able to generate dynamic unique public cryptocurrency addresses for each cryptocurrency stored on the wallet. In some embodiments, the total balance of fiat deposited by the user onto the platform may be displayed in the wallet. In some embodiments, the total balance of all cryptocurrencies and fiat currencies may be displayed in the wallet.

In some embodiments, tournament entry fees paid by users will also be added to the tournament escrow wallet/staking node to increase the prize pool. In some embodiments, prize pools can be released from escrow and distributed to winners after confirmation of the results (e.g., a check by the oracle token in relation to the game/match within a tournament, and in some embodiments, through confirmation by a compliance routine or compliance member's acknowledgement). In some embodiments, confirmation of the results are automated by the oracle or blockchain, which will use game data from games directly integrated with the platform to verify results, adjudicate the matches, release escrow, and pay out prizes via the platform's smart contract system.

In some embodiments, the framework can partially or completely autonomously adjudicate match outcomes. In some embodiments, games within tournaments and/or esports tournament outcomes can be determined by a combination of oracle functionality, smart contracts, and/or artificial intelligence/machine learning, in an automated manner, without the need for human intervention. In some embodiments, such match outcome adjudication functionality shall integrate with in-game data to be able to verifiably determine the match outcomes. According to some embodiments, any type of known or to be known algorithms, techniques and/or mechanisms for performing automatic in-game and/or post-game analysis can be utilized without departing from the scope of the instant disclosure. In some embodiments, third party validation checks (e.g., randomly and/or periodically) may also be performed to ensure accuracy of the automated match outcome adjudication. In some embodiments, such third parties can be a human and/or another COTS algorithm or technology operating independently of the framework.

In some embodiments, users are provided with capabilities, via the app, to withdraw their winnings/earnings in either cryptocurrency or fiat. In some embodiments, the framework provides the capabilities for converting fiat payments and payouts to and from cryptocurrency.

In some embodiments, the framework can be configured to implement advertising revenue models that enable revenue sharing with users and publishers, which can include, sponsors, game providers, network providers and/or gamers participating in, viewing and/or hosting the tournaments, and the like, and/or some combination thereof. In some embodiments, organizers can be incentivized to run events on the disclosed framework, as they will be able to charge a flat fee or percentage of the entry fees as an organizational fee. In some embodiments, competitors can be incentivized by the potential to win real prizes in mobile game tournaments, and earn tips paid by viewers.

According to some embodiments, the disclosed framework can be monetized to provide revenue streams based on, but not limited to, ad revenue (e.g., third party ad revenue), entry fees (e.g., a percentage of the entry fee can be charged prior to any fees collected by an organizer), transaction fees (e.g., charge fees for any transactions that occur over or on the app's platform), tokenization (e.g., an Ignite/TENKA® token offering), validation fees (e.g., collected from nodes used to process payments and payouts), subscription fees, sponsorship fees, ticketing fees, merchandise revenue, NFT integration and marketplace, and the like, or some combination thereof.

In some embodiments, the framework can be monetized on the blockchain or off. In some embodiments with no blockchain backing (e.g., “off chain”), third party integration may be required, and certain fees (e.g., transaction fees) must be split or provided for processing of payments/payouts. In some embodiments, fiat can be used for ad revenue sharing with users.

In some embodiments, where the disclosed framework is configured and executed with blockchain functionality (e.g., “on-chain”), transparency is provided, and crypto can be utilized due to the public nature of the ledger being utilized. In some embodiments, on-chain fees can be set and processed, thereby avoiding the need to pay additional transaction fees to a different blockchain (e.g., gas fees paid to process ERC20 transactions). In some embodiments, an escrow wallet or staking node can be utilized (as mentioned above), as well as oracle tokens which can be used to adjudicate tournament results.

In some embodiments, the platform may support gambling functionality for users to place side bets on matches. In some embodiments, viewers can bet on match win-loss outcomes, specific conditions during the game (e.g., how many points, kills, etc., are achieved by any one particular tournament entrant, whether a tournament entrant achieves a specific status or produces a scenario in the game, etc.). In some embodiments, the side bet fees operate functionally the same as entry fees, and are staked on-chain in an escrow node for the duration of the tournament. In some embodiments, the side bet mechanism of the platform is associated with specific tournament matches via a secondary betting interface.

In accordance with some embodiments, the present disclosure is configured to provide a novel framework for an esports mobile tournament streaming platform. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device (e.g., application server, messaging server, email server, ad server, content server and/or client device, and the like) cause at least one processor to perform a method for a novel and improved framework for an esports mobile tournament streaming platform.

In accordance with one or more embodiments, a system is provided that comprises one or more computers configured to provide functionality in accordance with such embodiments. In accordance with one or more embodiments, functionality is embodied in steps performed by at least one computer. In accordance with one or more embodiments, program code (or program logic) executed by a processor(s) of a computer to implement functionality in accordance with one or more such embodiments is embodied in, by and/or on a non-transitory computer-readable medium.

In some embodiments, the disclosure is directed to a system for electronic gaming comprising: one or more computers comprising one or more processors and one or more non-transitory computer readable media, the one or more non-transitory computer readable media comprising instructions stored thereon that, when executed, cause the one or more computers to implement steps. In some embodiments, the steps include generating, by the one or more processors, a gaming framework. In some embodiments, the steps include receiving, by the one or more processors, a request to create an electronic game. In some embodiments, the steps include enabling, by the one or more processors, access to registration for the electronic game, the access enabling a user to register electronically over a network. In some embodiments, the steps include collecting, by the one or more processors, entry information from a set of users, the entry information comprising electronic fund information and registration information. In some embodiments, the steps include associating, by the one or more processors, the collected entry information with a gaming ID. In some embodiments, the steps include issuing, by the one or more processors, one or more digital tokens to the user in exchange for cryptocurrency and/or fiat currency, wherein possession of at least one of the one or more digital tokens is required to participate in the electronic game.

In some embodiments, the one or more non-transitory computer readable media comprises further instructions stored thereon that when executed cause the one or more computers to implement steps that include electronically hosting, over the network, matches of the electronic game, wherein hosting enables each of the set of users to play assigned matches and/or view other matches via streams of each match, wherein results of each match are compiled in relation to participating users of a respective match.

In some embodiments, the one or more non-transitory computer readable media comprises further instructions stored thereon that when executed cause the one or more computers to implement steps that include determining, based on analysis of the matches, a winning user of the electronic game. In some embodiments, the steps include executing, by the one or more processors, a payout for the winning user, the payout comprising electronically transferring one or more of the one or more digital tokens from a digital wallet associated with the tournament to a digital wallet of the winning user.

In some embodiments, possession of the one or more digital tokens by a user enables one or more of engagement in a tournament, verification of results within the tournament, and reception of prizes, and/or advertisement revenue sharing. In some embodiments, the one or more digital tokens operate as a governance token. In some embodiments, the governance token provides voting rights to vote on one or more of rewards allocation, risk management, network upgrades, treasury management, council membership elections, and rates.

In some embodiments, the gaming framework is configured to enable the one or more digital tokens to be traded, bought, and/or sold. In some embodiments, the gaming framework is configured to enable the one or more digital tokens to be obtained by farming. In some embodiments, farming includes using a gamer's computer to execute algorithms associated with a blockchain technology. In some embodiments, the gaming framework includes an escrow protocol backed by a blockchain in accordance with smart contract terms.

In some embodiments, the one or more non-transitory computer readable media comprises further instructions stored thereon that when executed cause the one or more computers to implement steps that include associating, by the one or more processors, gamer points with the gaming ID. In some embodiments, the system is configured to apply a multiple to winning based on the gamer points.

In some embodiments, the one or more non-transitory computer readable media comprises further instructions stored thereon that when executed cause the one or more computers to implement steps that include generating, by the one or more processors, a proposal for a change in the gaming framework. In some embodiments, the proposal can only be submitted upon completion of a deposit. In some embodiments, the system is configured to hold the deposit until the proposal is accepted or rejected. In some embodiments, the deposit must be in the form of the one or more digital tokens.

It is understood that any reference to a “system” in this disclosure is also a reference to a method of providing a system performing the recited steps and/or functionality, and that the computer implemented steps described herein are also method steps executed by one or more processors. The system can therefore be described in terms of a method when defining the metes and bounds for protection sought. The following is an example of reciting some embodiments of the system as a method:

In some embodiments, the disclosure is directed to a method for electronic gaming comprising providing one or more computers comprising one or more processors and one or more non-transitory computer readable media, the one or more non-transitory computer readable media comprising instructions stored thereon that, when executed, cause the one or more computers to implement method steps. In some embodiments, the method steps include generating, by the one or more processors, a gaming framework. In some embodiments, the method steps include receiving, by the one or more processors, a request to create an electronic game. In some embodiments, the method steps include enabling, by the one or more processors, access to registration for the electronic game, the access enabling a user to a method of registering electronically over a network. In some embodiments, the method steps include collecting, by the one or more processors, entry information from a set of users, the entry information comprising electronic fund information and registration information. In some embodiments, the method steps include associating, by the one or more processors, the collected entry information with a gaming ID. In some embodiments, the method steps include issuing, by the one or more processors, one or more digital tokens to the user in exchange for cryptocurrency and/or fiat currency, wherein possession of at least one of the one or more digital tokens is required to participate in the electronic game.

In some embodiments, the one or more non-transitory computer readable media comprises further instructions stored thereon that when executed cause the one or more computers to implement method steps that include electronically hosting, over the network, matches of the electronic game, wherein a method of hosting enables each of the set of users to play assigned matches and/or view other matches via streams of each match, wherein results of each match are compiled in relation to participating users of a respective match.

In some embodiments, the one or more non-transitory computer readable media comprises further instructions stored thereon that when executed cause the one or more computers to implement method steps that include determining, based on analysis of the matches, a winning user of the electronic game. In some embodiments, the method steps include executing, by the one or more processors, a payout for the winning user, the payout comprising a method of electronically transferring one or more of the one or more digital tokens from a digital wallet associated with the tournament to a digital wallet of the winning user.

In some embodiments, possession of the one or more digital tokens by a user enables one or more of engagement in a tournament, verification of results within the tournament, and reception of prizes, and/or advertisement revenue sharing. In some embodiments, a method step includes the one or more digital tokens operating as a governance token. In some embodiments, a method step includes the governance token providing voting rights to vote on one or more of rewards allocation, risk management, network upgrades, treasury management, council membership elections, and rates.

In some embodiments, the gaming framework is configured to enable a method of enabling the one or more digital tokens to be traded, bought, and/or sold. In some embodiments, the gaming framework is configured to enable a method of the one or more digital tokens to be obtained by farming. In some embodiments, a method of farming includes using a gamer's computer to execute algorithms associated with a blockchain technology. In some embodiments, the gaming framework includes a method of implementing an escrow protocol backed by a blockchain in accordance with smart contract terms.

In some embodiments, the one or more non-transitory computer readable media comprises further instructions stored thereon that when executed cause the one or more computers to implement method steps that include associating, by the one or more processors, gamer points with the gaming ID. In some embodiments, a method step includes applying a multiple to winning based on the gamer points.

In some embodiments, the one or more non-transitory computer readable media comprises further instructions stored thereon that when executed cause the one or more computers to implement method steps that include generating, by the one or more processors, a proposal for a change in the gaming framework. In some embodiments, a method step includes the proposal only being able to be submitted upon completion of a deposit. In some embodiments, the method step includes holding the deposit until the proposal is accepted or rejected. In some embodiments, a method step includes requiring the deposit to be in the form of the one or more digital tokens.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating an example of a network within which the systems and methods disclosed herein could be implemented according to some embodiments of the present disclosure;

FIG. 2 depicts is a schematic diagram illustrating an example of client device in accordance with some embodiments of the present disclosure;

FIG. 3 is a block diagram illustrating components of an exemplary system in accordance with embodiments of the present disclosure;

FIGS. 4A-4B illustrate exemplary examples of network architecture in accordance with some embodiments of the present disclosure;

FIGS. 5A-5B illustrate exemplary examples of network architecture in accordance with some embodiments of the present disclosure;

FIG. 6 illustrates an exemplary example of network architecture in accordance with some embodiments of the present disclosure;

FIG. 7 is a block diagram illustrating an exemplary data flow in accordance with some embodiments of the present disclosure; and

FIG. 8 is a block diagram illustrating an exemplary data flow in accordance with some embodiments of the present disclosure.

FIG. 9 shows a TENKA® token overview according to some embodiments.

FIG. 10 shows a weighted winnings distribution example using three places with 50%, 33% and 16% prize splits according to some embodiments.

### DESCRIPTION OF EMBODIMENTS

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and are representative of computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2nd, 3rd, 4^{th} or 5^{th} generation (2G, 3G, 4G or 5G) cellular technology, mobile edge computing (MEC), BLUETOOTH, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device (i.e., computer) may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

As discussed herein, reference to an “advertisement” should be understood to include, but not be limited to, digital media content embodied as a media item that provides information provided by another user, service, third party, entity, and the like. Such digital ad content can include any type of known or to be known media renderable by a computing device, including, but not limited to, video, text, audio, images, and/or any other type of known or to be known multi-media item or object. In some embodiments, the digital ad content can be formatted as hyperlinked multimedia content that provides deep-linking features and/or capabilities. Therefore, while some content is referred to as an advertisement, the content is still a digital media item that is renderable by a computing device, and such digital media item comprises content relaying promotional content provided by a network associated party.

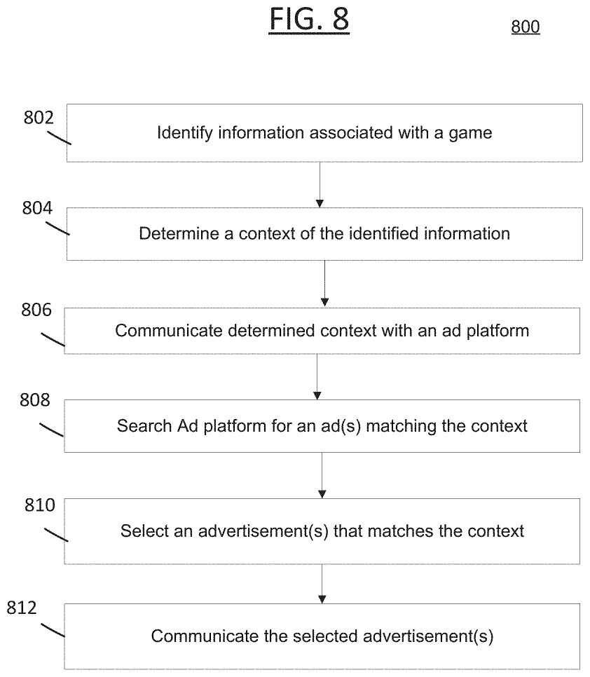

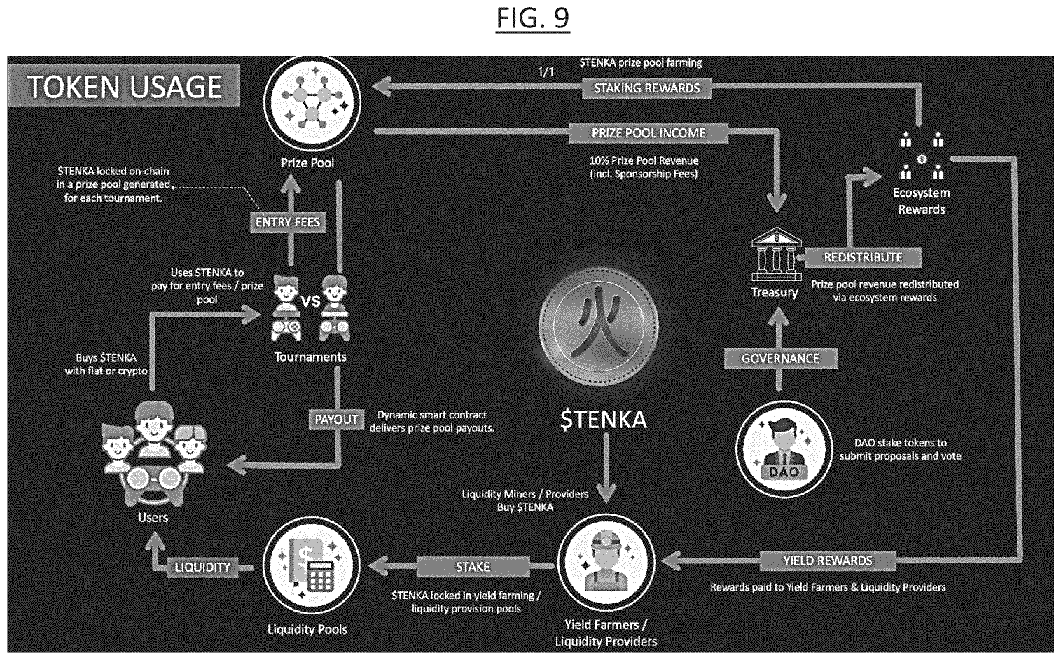

As discussed in more detail below at least in relation to FIG. 8, according to some embodiments, information associated with, derived from, or otherwise identified from, during or as a result or part of a tournament, as discussed herein, can be used for monetization purposes and targeted advertising when providing, delivering or enabling such devices access to content or services over a network. Providing targeted advertising to users associated with such discovered content can lead to an increased click-through rate (CTR) of such ads and/or an increase in the advertiser's return on investment (ROI) for serving such content provided by third parties (e.g., digital advertisement content provided by an advertiser, where the advertiser can be a third party advertiser, or an entity directly associated with or hosting the systems and methods discussed herein).

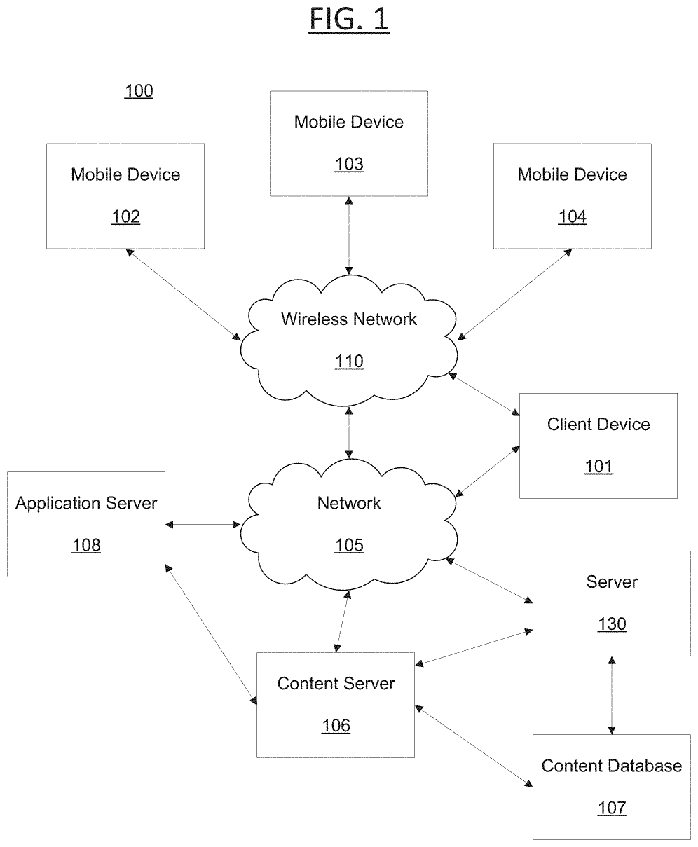

Certain embodiments will now be described in greater detail with reference to the figures. In general, with reference to FIG. 1, a system 100 in accordance with an embodiment of the present disclosure is shown. FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 of FIG. 1 includes local area networks (“LANs”)/wide area networks (“WANs”)—network 105, wireless network 110, mobile devices (client devices) 102-104 and client device 101. FIG. 1 additionally includes a variety of servers, such as content server 106, application (or “App”) server 108 and third party server 130.

One embodiment of mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information, as discussed above.

Mobile devices 102-104 also may include at least one client application that is configured to receive content from another computing device. In some embodiments, mobile devices 102-104 may also communicate with non-mobile client devices, such as client device 101, or the like. In one embodiment, such communications may include sending and/or receiving messages, posting on social media, engaging in an online game, searching for, viewing and/or sharing memes, photographs, digital images, audio clips, video clips, or any of a variety of other forms of communications.

Client devices 101-104 may be capable of sending or receiving signals, such as via a wired or wireless network, or may be capable of processing or storing signals, such as in memory as physical memory states, and may, therefore, operate as a server.

Wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104.

Network 105 is configured to couple content server 106, application server 108, or the like, with other computing devices, including client device 101, and through wireless network 110 to mobile devices 102-104. Network 105 is enabled to employ any form of computer readable media or network for communicating information from one electronic device to another.

The content server 106 may include a device that includes a configuration to provide any type or form of content via a network to another device. Devices that may operate as content server 106 include personal computers (PCs), desktop computers, multiprocessor systems, microprocessor-based or programmable consumer electronics, network PCs, servers, and the like. Content server 106 can further provide a variety of services that include, but are not limited to, gaming services, email services, instant messaging (IM) services, streaming and/or downloading media services, search services, photo services, web services, social networking services, news services, third-party services, audio services, video services, SMS services, MMS services, FTP services, voice over IP (VOIP) services, or the like.

In some embodiments, third party server 130 can comprise a server that stores online advertisements for presentation to users. “Ad serving” refers to methods used to place online advertisements on websites, in applications, or other places where users are more likely to see them, such as during an online session or during computing platform use, for example. In some embodiments, various monetization techniques or models may be used in connection with sponsored advertising, including advertising associated with user data. In some embodiments, such sponsored advertising includes monetization techniques including sponsored search advertising, non-sponsored search advertising, guaranteed and non-guaranteed delivery advertising, ad networks/exchanges, ad targeting, ad serving and ad analytics. In some embodiments, such systems can incorporate near instantaneous auctions of ad placement opportunities, with higher quality ad placement opportunities resulting in higher revenues per ad. That is, in some embodiments, advertisers will pay higher advertising rates when they believe their ads are being placed in or along with highly relevant content that is being presented to users. In some embodiments, reductions in the time needed to quantify a high quality ad placement offers ad platforms competitive advantages. Thus, higher speeds and more relevant context detection improve these technological fields according to some embodiments.

For example, in some embodiments, a process of buying or selling online advertisements may involve a number of different entities, including advertisers, publishers, agencies, networks, or developers. To simplify this process, in some embodiments, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en-masse to advertisers.

For example, in some embodiments, an approach includes profile-type ad targeting. In this approach, user profiles specific to a user may be generated to model user behavior, for example, by tracking a user's gaming activities, and compiling a profile based at least in part on games or tournaments engaged within, and/or advertisements ultimately delivered. A correlation may be identified by the system in some embodiments, such as for user purchases, for example. In some embodiments, an identified correlation may be used by the system to target potential purchasers by targeting content or advertisements to particular users. In some embodiments, during presentation of advertisements, a presentation system may collect descriptive content about types of advertisements presented to users. In some embodiments, a broad range of descriptive content may be gathered, including content specific to an advertising presentation system. In some embodiments, advertising analytics gathered by the system may be transmitted to locations remote to an advertising presentation system for storage or for further evaluation. Where advertising analytics transmittal is not immediately available, gathered advertising analytics may be stored by an advertising presentation system until transmittal of those advertising analytics becomes available according to some embodiments.

In some embodiments, users are able to access services provided by servers 106, 108 and/or 130. This may include in a non-limiting example, gaming servers, authentication servers, search servers, email servers, social networking services servers, SMS servers, IM servers, MMS servers, exchange servers, photo-sharing services servers, and travel services servers, via the network 105 using their various devices 101-104 according to some embodiments.

In some embodiments, applications, such as, but not limited to, gaming applications, coin-based wallet applications, banking applications, news applications, mail applications, instant messaging applications, social networking applications, search applications, and the like, can be hosted by the application server 108, or content server 106 and the like.

Thus, the application server 108, for example, can store various types of applications and application related information including application data and user profile information (e.g., identifying and behavioral information associated with a user) according to some embodiments. It should also be understood that content server 106 can also store various types of data related to the content and services provided by content server 106 in an associated content database 107 in some embodiments, as discussed in more detail below. In some embodiments, the network 105 is also coupled with/connected to a Trusted Search Server (TSS) which can be utilized to render content in accordance with some embodiments discussed herein. In some embodiments, the TSS functionality can be embodied within servers 106, 108 and/or 130.

Moreover, although FIG. 1 illustrates servers 106, 108 and 130 as single computing devices, respectively, in some embodiments the disclosure is not so limited. For example, in some embodiments, one or more functions of servers 106, 108 and/or 130 may be distributed across one or more distinct computing devices. Moreover, in some embodiment, servers 106, 108 and/or 130 may be integrated into a single computing device, without departing from the scope of the present disclosure.

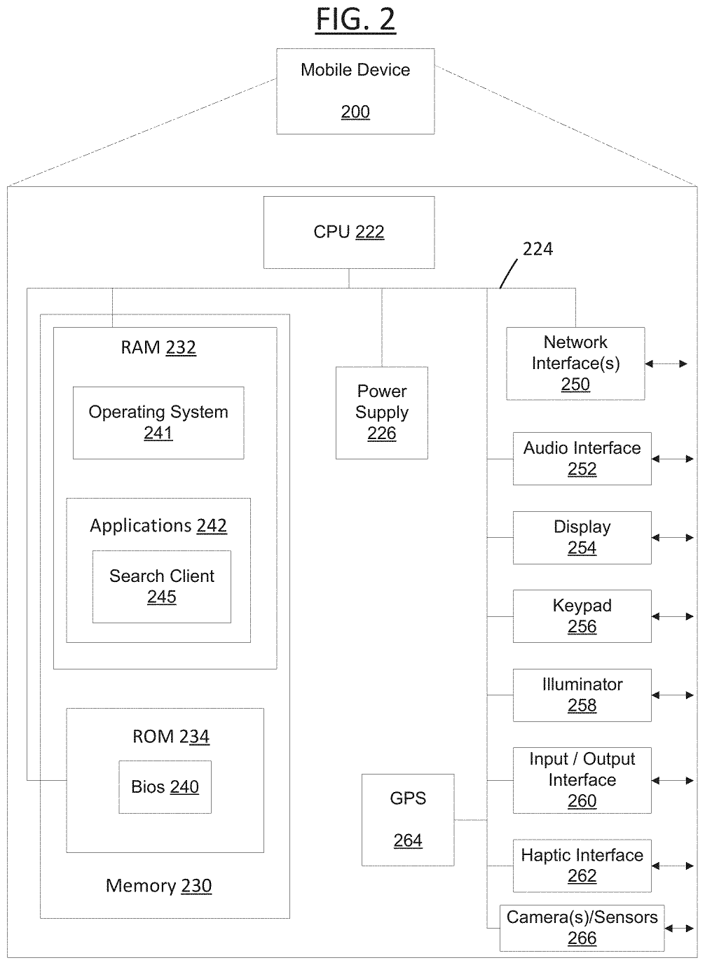

FIG. 2 is a schematic diagram illustrating a client device showing an example embodiment of a client device that may be used within the present disclosure. In some embodiments, client device 200 may include many more or less components than those shown in FIG. 2. However, in some embodiments, the components shown are sufficient to disclose an illustrative embodiment for implementing the present disclosure. In some embodiments, client device 200 may represent, for example, client devices discussed above in relation to FIG. 1.

As shown in the figure, In some embodiments, client device 200 includes a processing unit (CPU) 222 in communication with a mass memory 230 via a bus 224. In some embodiments, client device 200 also includes a power supply 226, one or more network interfaces 250, an audio interface 252, a display 254, a keypad 256, an illuminator 258, an input/output interface 260, a haptic interface 262, an optional global positioning systems (GPS) receiver 264 and a camera(s) or other optical, thermal or electromagnetic sensors 266. In some embodiments, device 200 can include one camera/sensor 266, or a plurality of cameras/sensors 266, as understood by those of skill in the art. In some embodiments, power supply 226 provides power to Client device 200.

In some embodiments, client device 200 may optionally communicate with a base station (not shown), or directly with another computing device. In some embodiments, network interface 250 is sometimes known as a transceiver, transceiving device, or network interface card (NIC).

In some embodiments, audio interface 252 is arranged to produce and receive audio signals such as the sound of a human voice. In some embodiments, display 254 may be a liquid crystal display (LCD), gas plasma, light emitting diode (LED), or any other type of display used with a computing device. In some embodiments, display 254 may also include a touch sensitive screen arranged to receive input from an object such as a stylus or a digit from a human hand.

In some embodiments, keypad 256 may comprise any input device arranged to receive input from a user. In some embodiments, illuminator 258 may provide a status indication and/or provide light.

In some embodiments, client device 200 also comprises input/output interface 260 for communicating with external hardware and/or software. In some embodiments, input/output interface 260 can utilize one or more communication technologies, such as USB, infrared, Bluetooth™, or the like. In some embodiments, haptic interface 262 is arranged to provide tactile feedback to a user of the client device.

In some embodiments, optional GPS transceiver 264 can determine the physical coordinates of client device 200 on the surface of the Earth, which typically outputs a location as latitude and longitude values. In some embodiments, GPS transceiver 264 can also employ other geo-positioning mechanisms, including, but not limited to, triangulation, assisted GPS (AGPS), E-OTD, CI, SAI, ETA, BSS or the like, to further determine the physical location of Client device 200 on the surface of the Earth. In some embodiments, however, Client device may through other components, provide other information that may be employed to determine a physical location of the device, including for example, a MAC address, Internet Protocol (IP) address, or the like.

In some embodiments, mass memory 230 includes a RAM 232, a ROM 234, and other storage means. In some embodiments, mass memory 230 illustrates another example of computer storage media for storage of information such as computer readable instructions, data structures, program modules or other data. In some embodiments, mass memory 230 stores a basic input/output system (“BIOS”) 240 for controlling low-level operation of Client device 200. The mass memory also stores an operating system 241 for controlling the operation of Client device 200

In some embodiments, memory 230 further includes one or more data stores, which can be utilized by client device 200 to store, among other things, applications 242 and/or other information or data. For example, in some embodiments, data stores may be employed to store information that describes various capabilities of client device 200. The information may then be provided to another device based on any of a variety of events, including being sent as part of a header (e.g., index file of the HLS stream) during a communication, sent upon request, or the like. In some embodiments, at least a portion of the capability information may also be stored on a disk drive or other storage medium (not shown) within client device 200.

In some embodiments, applications 242 may include computer executable instructions which, when executed by client device 200, transmit, receive, and/or otherwise process audio, video, images, and enable telecommunication with a server and/or another user of another client device. In some embodiments, applications 242 may further include search client 245 that is configured to send, to receive, and/or to otherwise process a search query and/or search result.

Having described the components of the general architecture employed within the disclosed systems and methods, the components' general operation with respect to the disclosed systems and methods according to some embodiments will now be described below.

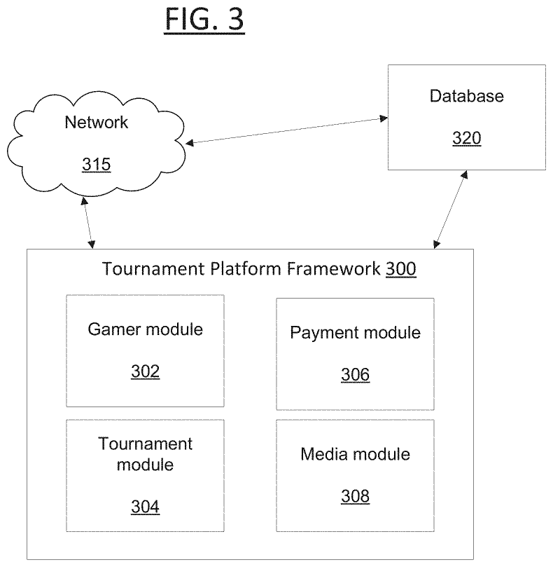

FIG. 3 is a block diagram illustrating the components for performing the systems and methods discussed herein according to some embodiments. FIG. 3 includes tournament platform framework 300, network 315 and database 320 according to some embodiments. In some embodiments, the tournament platform framework 300 can be a special purpose machine or processor and could be hosted by a cloud server (e.g., cloud web services server(s)), messaging server, application server, content server, social networking server, web server, search server, content provider, third party server, user's computing device, and the like, or any combination thereof.

According to some embodiments, tournament platform framework 300 can be embodied as a stand-alone application that executes on a networking server. In some embodiments, the tournament platform framework 300 can function as an application installed on the user's device, and in some embodiments, such an application can be a web-based application accessed by the user device over a network. In some embodiments, the tournament platform framework 300 can be configured and/or installed as an augmenting script, program or application (e.g., a plug-in or extension) to another application or portal data structure.

In some embodiments, the database 320 can be any type of database or memory, and can be associated with a content server on a network (e.g., gaming server, content server, a search server or application server) or a user's device (e.g., device 101-104 or device 200 from FIGS. 1-2). In some embodiments, database 320 comprises a dataset of data and metadata associated with local and/or network information related to users, services, applications, content and the like.

In some embodiments, such information can be stored and indexed in the database 320 independently and/or as a linked or associated dataset. In some embodiments, the database 320 can be a distributed ledger (e.g., Blockchain), as discussed below. As discussed above, it should be understood that the data (and metadata) in the database 320 can be any type of information and type, whether known or to be known, without departing from the scope of the present disclosure according to some embodiments.

In some embodiments, database 320 can store data for users, e.g., user data. According to some embodiments, the stored user data can include, but is not limited to, information associated with one or more of a user's profile, user interests, user behavioral information, user patterns, user attributes, user preferences or settings, user demographic information, user location information, user biographic information, and the like, or some combination thereof. In some embodiments, the user data can also include user device information, including, but not limited to, device identifying information, device capability information, voice/data carrier information, IP address, applications installed or capable of being installed or executed on such device, and/or any, or some combination thereof. It should be understood that the data (and metadata) in the database 320 can be any type of information related to a user, content, a device, an application, a service provider, a content provider, whether known or to be known, without departing from the scope of the present disclosure according to some embodiments.

In some embodiments, database 320 can store data and metadata associated with users, gaming activities, payment activities and/or accounts, messages, images, videos, text, products, items and services from an assortment of media, applications and/or service providers and/or platforms, and the like. Accordingly, in some embodiments, any other type of known or to be known attribute or feature associated with a user, tournament, game or gaming activity, message, data item, media item, login, logout, website, application, communication (e.g., a message) and/or its transmission over a network, a user and/or content included therein, or some combination thereof, can be saved as part of the data/metadata in datastore 320.

As discussed above, with reference to FIG. 1, in some embodiments, the network 315 can be any type of network such as, but not limited to, a wireless network, a local area network (LAN), wide area network (WAN), the Internet, or a combination thereof. In some embodiments, the network 315 facilitates connectivity of the tournament platform framework 300, and the database of stored resources 320. Indeed, as illustrated in FIG. 3, in some embodiments, the tournament platform framework 300 and database 320 can be directly connected by any known or to be known method of connecting and/or enabling communication between such devices and resources.

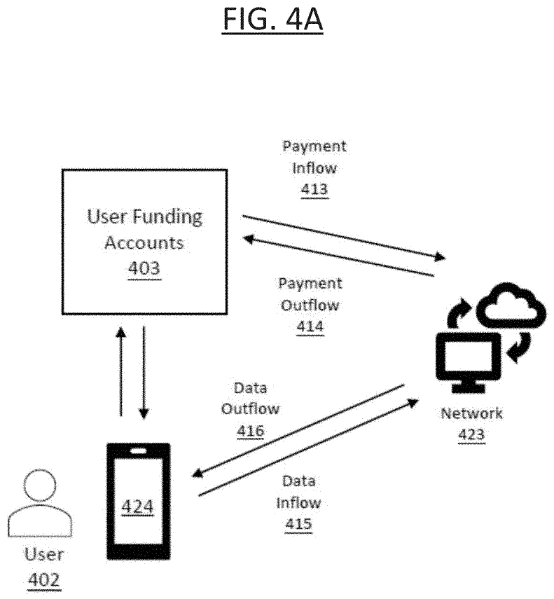

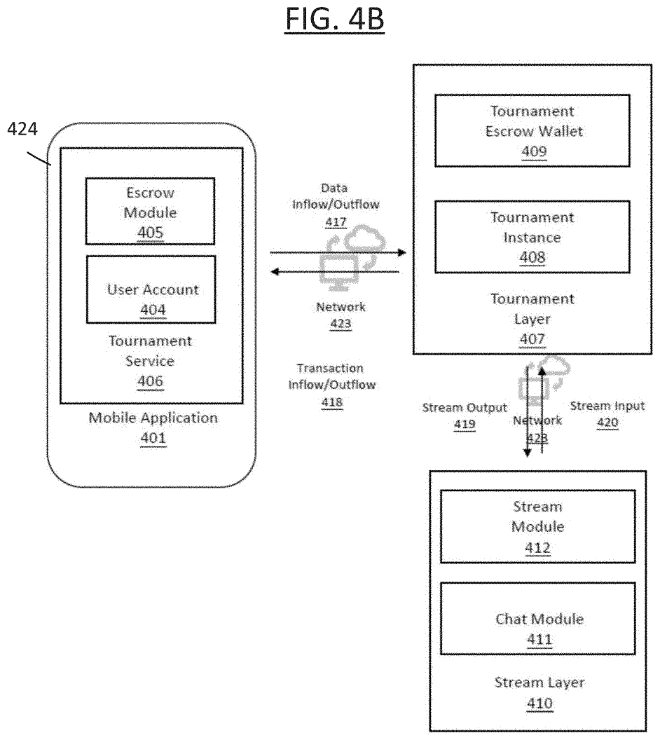

In some embodiments, the principal processor, server, or combination of devices that comprise hardware programmed in accordance with the special purpose functions herein is referred to for convenience as tournament platform framework 300 (embodied in some embodiments as app 401, discussed below), and includes gamer module 302, tournament module 304, payment module 306 and media module 308 as discussed below in more detail in relation to at least FIGS. 4A-7.

For example, in some embodiments, the gamer module 302 can handle the processing associated with a gamer's account, activity and set-up or entry into a tournament, as discussed below; tournament module 304 can handle the processing associated with establishing, organizing, hosting and executing a tournament, as discussed below; payment module 306 can handle the processing associated with payments and payouts, as well as currency exchanges, as discussed below; and media module 308 can handle the processing associated with the streaming, live-chatting and/or social integration, as discussed below.

Thus, FIGS. 4A-7 provide non-limiting example embodiments of framework 300, and its sub-modules 302-308 operation for providing the functionality for the esports mobile gaming platform discussed herein.

It should be understood that the framework and modules (or engine(s)) discussed herein are non-exhaustive, as additional or fewer engines and/or modules (or sub-modules) may be applicable to the embodiments of the systems and methods discussed according to some embodiments. The operations, configurations and functionalities of each module, and their role within some embodiments of the present disclosure will be discussed below.

FIGS. 4A-4B provide non-limiting example embodiments of the network architecture for the tournament platform framework. A general view of the framework according to some embodiments is depicted in FIG. 4A, which illustrates a user 402, user's device (e.g., smartphone) 424, user funding accounts 403, and network 423. According to some embodiments, network 423 embodies at least one of the wired or wireless networks discussed above in relation to at least FIGS. 1 and 3. In some embodiments, user 402 is a gamer, and user device 424 is a client device as discussed above at least in relation to FIG. 2.

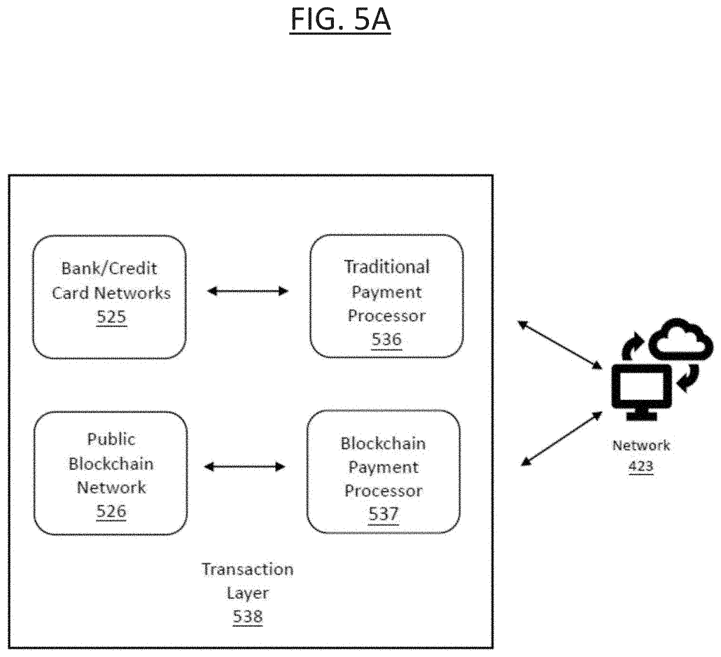

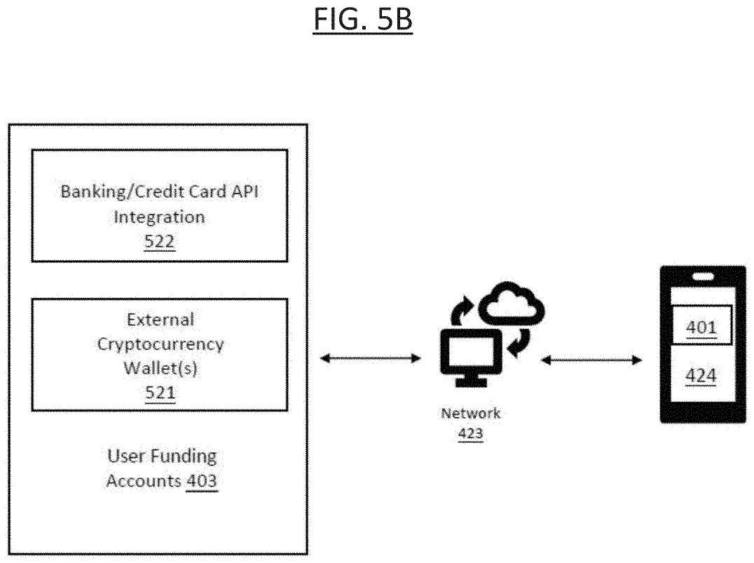

According to some embodiments, user funding accounts 403 can represent a financial institution, application, or account where electronic funds can be transferred from an account of a user for use within a tournament (e.g., as payment of an entry fee, for example). In some embodiments, the account can be associated with a bank, credit card company, personal wallet account, or coin-wallet (e.g., Coinbase®) account, for example (as discussed below in relation to at least FIG. 5B). In some embodiments, accounts 403 enables electronic funds to be transferred out at payment outflow 414 and received as payment inflow 413 over network 423 to a tournament, as discussed below.

According to some embodiments, data outflow 416 corresponds to device, user and/or gaming data transferred from the device 424 over the network 423 for account set up, entry, game play and/or results related processing of a tournament, as discussed below. In some embodiments, data inflow 415 corresponds to similar processing for an account set up, or tournament action, as discussed below.

FIG. 4B, provides an example embodiment of device 424 and its communication with a tournament (e.g., via tournament layer 407) and a gaming stream (e.g., via stream layer 410) according to some embodiments. In some embodiments, device 424 executes mobile application 401 (e.g., as discussed above can be in association with capabilities of framework 300). Application 401, in some embodiments, comprises functionality for connecting to a tournament, via tournament service 406, establishing a user account 404 and enabling the transfer of funds to/from accounts 403, via escrow module 405.

According to some embodiments, tournament layer 407 can be hosted on another user device, or on a server or within a cloud server/device (e.g., any of the devices listed in FIG. 1, as discussed above). Tournament layer 407 includes the functionality for initiating and hosting a gaming tournament, inclusive of accepting entry fees, processing payments, other types of electronic funds transfers, conversions and the like, via tournament escrow wallet 409. Layer 407 further includes tournament instance 408, which is a module/engine that enables the establishing and hosting of the tournament.

In some embodiments, when competitors and an organizer(s) enter a tournament, the tournament layer 407 can cause the mobile application 401 to generate an overlay that can sit above a third party mobile game (e.g., stream layer 410) or can run in the background. In some embodiments, layer 407 provides competitors with functionality (e.g., competitors can press a button or provide another form of voice, text, biometric, and the like input) to record their screen/device audio. This input is then sent to the mobile application 401 to run in the background so that it does not impact their gameplay.

In some embodiments, escrow module 405 and escrow wallet 409 communicate over network 423 for the electronic funds transfer, as discussed above, and illustrated by transaction inflow/outflow 418 (in a similar manner as in FIG. 4A, items 415/416). In some embodiments, as discussed below, escrow wallet 409 can be configured with any desired escrow protocol.

In some embodiments, device 424 engages in and/or participates in a tournament through interaction with layer 407 over network 423, as illustrated by data inflow/outflow 417 (in a similar manner as in FIG. 4A, items 413/414).

In some embodiments, tournament layer 407 also interacts over network 423 with stream layer 410. In some embodiments, the interaction occurs via stream output 419 and stream input 420. As discussed below, in some embodiments, stream output can be the display of a game play, live-chat and/or social posting produced by stream layer 407, which is then transferred to tournament layer 407 for review and/or processing and then sent to device 424. In some embodiments, stream input 420 can be the inputs from device 424 which are relayed to stream layer 407 via tournament layer 407. In some embodiments (not shown), device 424 can interact directly with stream layer 410 in a similar manner as discussed herein, without departing from the scope of the instant disclosure.

In some embodiments, stream layer 410 can be hosted on another user device, or on a server or within a cloud server/device (e.g., any of the devices listed in FIG. 1, as discussed above). In some embodiments, stream layer 407 includes stream module 412 which enables the streaming capabilities for gameplay, viewership and/or other types of participation of a game's visible display, as discussed above. For example, in some embodiments, a master screen is displayed, that can be toggled to view other matches within a tournament, as discussed above. In some embodiments, module 412 enables the engagement of other platforms, such as Twitch® and YouTube®, for example.

In some embodiments, stream layer 410 further includes chat module 411. In some embodiments, module 411 can include functionality for the real-time chat capabilities and/or social capabilities, as discussed above. For example, in some embodiments, as a game is being streamed, the competitors participating in the match and/or viewing users can chat live. The chat window can be positioned next to or below the displayed stream's output, or overlaid (at most partially or transparently so that the stream is still viewable). In some embodiments, module 411 further includes abilities for competitors and/or viewers to post in real-time to social platforms, and/or view social activities related to the match (e.g., see live posts (e.g., Tweets®) related to a current match).

FIGS. 5A-5B illustrate non-limiting example embodiments of network architecture for interactions of a transaction layer 538 related to electronic funds processing, as discussed herein. In some embodiments, layer 538 can be hosted on another user device, or on a server or within a cloud server/device (e.g., any of the devices listed in FIG. 1, as discussed above). Layer 538 is configured to interact over network 423 with user 401 via device 423, as discussed below.

In some embodiments, as illustrated in FIG. 5A, layer 538 can include bank/credit card networks 525, traditional payment processor 536, public (or private) blockchain network 526 and blockchain payment processor 537. According to some embodiments, bank/credit card networks 525, traditional payment processor 536, public blockchain network 526 and blockchain payment processor 537 can be configured as modules, engines or components of layer 538. In some embodiments, bank/credit card networks 525 interacts and communicates with traditional payment processor 536. In some embodiments, public blockchain network 526 interacts and/or communicates with blockchain payment processor 537.

According to some embodiments, bank/credit card networks 525 can correspond to financial institutions and accounts of the user hosted therein. For example, in some embodiments, account information and/or electronic fund data of the user's bank account, and/or credit limit for a credit card account of the user. In some embodiments, transaction layer 538 includes traditional payment processor 536 for processing of electronic funds to/from networks 525.

According to some embodiments, public blockchain network can correspond to a publicly available distributed ledger for housing cryptocurrencies owned and/or utilized by the user (e.g., Bitcoin, for example). For example, network 526 can be associated with a Coinbase® account of the user, or other crypto-wallet the user utilizes for storing, purchasing and/or transferring cryptocurrencies. The crypto-data for the user housed in network 526 is processed by blockchain payment processor 537 of layer 538 in some embodiments.

In FIG. 5B, user funding accounts 403, which can be associated with bank/credit card networks 525 and/or public blockchain network 526 in some embodiments, can include modules, engines and/or components such as, but not limited to, banking/credit card application programming interface (API) 522 and external cryptocurrency wallet(s) 521. In some embodiments, API 522 can provide or correspond to functionality for processing of electronic funds from networks 525, and in some embodiments, wallet(s) 521 can provide or correspond to functionality for processing of electronic funds from network 526.

As depicted in FIG. 5B, and discussed above in relation to at least FIG. 4A, in some embodiments, the accounts 403 can be interacted with, provide information to/from and/or provide access to account information in relation to user 401 and user device 423. In some embodiments, accounts 403 can be hosted by transaction layer 538 (of FIG. 5A).

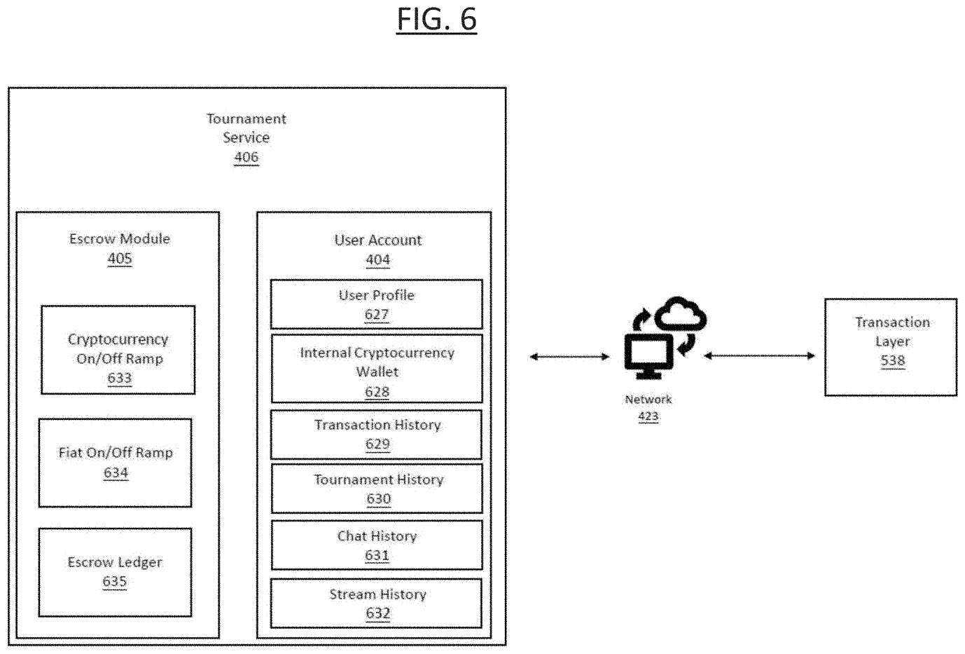

Turning to FIG. 6, a non-limiting example embodiment of network architecture for tournament service 406's interaction over network 423 with transaction layer 538 is depicted. In some embodiments, tournament service 406 includes, but is not limited to, escrow module 405, and user account 404. The data stored and/or transmitted to/from module 405 and account 404 are transferred to, accessible to/from and/or received from layer 538 and its components, as discussed above.

In some embodiments escrow module 405 includes modules, engines and/or components, such as, cryptocurrency on/off ramp 633, fiat on/off ramp 634 and escrow ledger 635. According to some embodiments, cryptocurrency on/off ramp 633 is a component that can be configured for receiving crypto-fees from layer 538, and then providing them to the user accounts accessible via layer 538, as discussed above (e.g., receiving entry fees, and/or providing prizes). In some embodiments, cryptocurrency on/off ramp can transfer funds from or provide funds to a user's account on blockchain network 526.

In some embodiments, fiat on/off ramp 634 is a component that can be configured for receiving fiat-fees (e.g., electronic funds, such as, for example, the USD) from layer 538, and then providing them to the user accounts accessible via layer 538, as discussed above (e.g., receiving entry fees, and/or providing prizes). In some embodiments, such fiat funds may include funds from a user's account on bank/credit card network 525.

In some embodiments, escrow ledger 635 is a record of transactions handled and processed by escrow module 405. As discussed above, the transactions can include, but are not limited to, entry fees, processing fees, transactions fees, revenue sharing, and the like or some combination thereof.

In some embodiments, user account 404 includes modules, engines and/or components, such as, user profile 627, internal cryptocurrency wallet 628, transaction history 629, tournament history 630, chat history 631 and stream history 632. Thus, the user account 404 includes information related to, but not limited to, a user's gaming activity, whether its participation in a tournament, chatting with other users, posting on social media and/or viewing a match, for example.

In some embodiments, user profile 627 comprises information related to, but not limited to, a gamer's username, demographics, win-loss record, overall ranking, and the like. In some embodiments, internal cryptocurrency wallet 628 can include information related to, but not limited to, the user's crypto-data, which can include payments, value of owned crypto, location of crypto, type of crypto, payouts, and the like. In some embodiments, wallet 628 can be a digital wallet provided by or directly associated with mobile application 401. In some embodiments, the token issued by the framework (e.g., Ignite/TENKA® token, as discussed above), can be stored in wallet 628.

In some embodiments, transaction history 629 can include information related to, but not limited to, payments, payouts, and the types thereof (e.g., fiat and/or crypto), and the like.

In some embodiments, tournament history 630 can include information related to, but not limited to, the identity of tournaments played in, which tournaments have been viewed, win-loss record, scores/tallies for each match and/or tournament, placement in tournaments, rankings within tournaments and/or overall, types or identities of games, and the like.

In some embodiments, chat history 631 can include information related to, but not limited to, which other users have been engaged in chat/social post, content of the chats/posts, a derived context of the chat/post, social platforms engaged (e.g., Twitter®, for example), which games, matches and/or tournaments were streaming during the chat/post, and the like. It should be understood that chat history 631 can correspond to both chat and social functionality.

In some embodiments, each tournament can have an individual chat instance. In some embodiments, each match may have an individual chat instance. In some embodiments, each instance can be stored accordingly (e.g., with reference to the tournament and/or match) in chat history 631.

In some embodiments, stream history 632 can include information related to, but not limited to, which games have been streamed, types of streams, platforms of streams (e.g., Twitch®, YouTube®), whether master or other streams were viewed, how long each stream was viewed, whether other user's watched the user's stream, and the like, or some combination thereof.

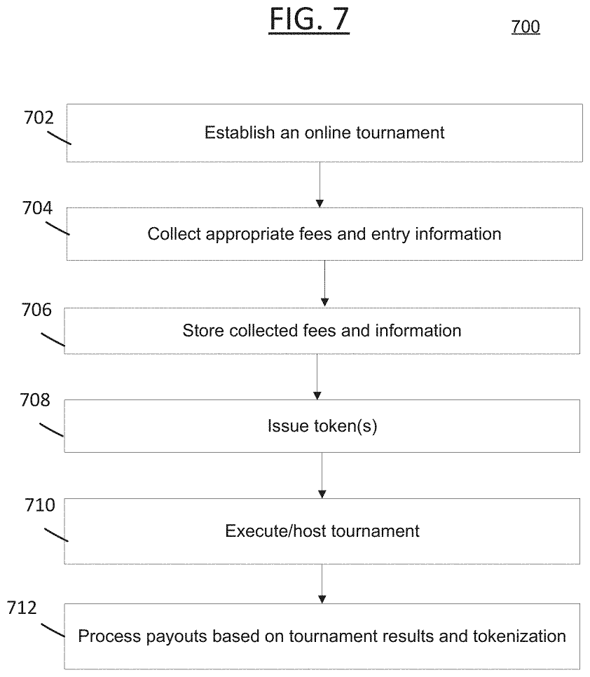

Turning to FIG. 7, Process 700 is disclosed which details an exemplary gaming tournament and payment operation(s) according to some embodiments of the present disclosure. In some embodiments, process 700 can be implemented and/or executed via framework 300 operating within the network environments depicted in FIGS. 4A-6.

According to some embodiments, framework 300 can be embodied or executed in accordance with a mobile application (e.g., application 401, as discussed above). In some embodiments, the mobile application allows users to organize and stream esports tournaments on mobile devices, stake prize pools in cryptocurrency, and pay out in either crypto or fiat. According to some embodiments, the application requires users to pass through Know your Customer (or Client) (KYC) processing in order to be able to compete for paid tournaments.

In some embodiments, the framework 300 can sort users into verified and unverified users (for example, this can be performed by tournament layer 407, as discussed above). In some embodiments, unverified users can compete in free/paid tournaments but may not be able to cash out any winnings. In some embodiments, verified users can compete in paid or free tournaments, and can be able to cash out winnings. In some embodiments, the creation of a tournament can involve creation of a “gate” (e.g., verification processing step and/or firewall, for example) for unverified users that will block them from being able to withdraw funds (at least until verified or when they provide the requisite credentials or token).

According to some embodiments, upon user registration, each user is assigned a wallet built into the application with multiple forms of crypto and fiat wallets (e.g., wallet 628, as discussed above). In some embodiments, the wallet can combine an entire portfolio and add it up to show users the value of what users have deposited. In some embodiments, the internal, proprietary wallet to the application (e.g., wallet 628 to application 401) may be the default wallet for this form of processing.

According to some embodiments, when fiat or other forms of traditional currency are received, or digital or electronic versions of it are identified, retrieved or received from a user's account (e.g., network 525), application 401 is capable of modifying the data structures and converting them, or replacing them, with their cryptographic equivalent. In some embodiments, application 401 can issue the Ignite/TENKA® token that represents the entry and access to a tournament, and represents the equivalent value of the converted electronic funds. According to some embodiments, such processing can be performed via fiat on/off ramp 634 and/or cryptocurrency on/off ramp 633.

According to some embodiments, users can be sorted and/or identified according to a set of different categories or classes. Such categories can include, but are not limited to: organizer, moderator, competitor, viewer. In some embodiments, a user can be classified as one or more categories (for example, an organizer and a viewer). In some embodiments, organizers can designate additional organizers/moderators to assist with moderation of events. In some embodiments, only the organizer who creates the tournament has power over master video switching of the entire tournament.

According to some embodiments, a user can trigger the creation of a unique tournament, referred to as a tournament session. The session can include, and/or be associated with, an escrow wallet that is specifically generated for that individual tournament, and shows the contents of the staking node for all users to stake on-chain. For example, a tournament's wallet can provide information related to the type of game, identity of game, number of matches, tournament configuration, tournament rules and scoring, competitors, prizes, and type of prizes (e.g., on-chain provides cryptocurrencies, and off-chain provides fiats), NFT(s) for the tournament or individual matches, and the like, or some combination thereof.

In some embodiments, potential winnings or other prizes (e.g., high score, or best defense, for example) can be calculated based on the electronic fund information represented in the wallet after all fees are deducted for hosting the tournament and processing the entry fees (e.g., transaction fees, server hosting fees, for example).

In some embodiments, the framework 300 can provide mechanisms to spin up (e.g., create, modify and enhance, or in some embodiments, reduce) an individual staking node. In some embodiments, such alternation can specifically be used as an escrow prize pool, such that it is available for a paid tournament (e.g., free tournaments may not have this functionality). In some alternative embodiments, however, free tournaments (e.g., tournaments with no required entry fees) can have this functionality as the escrow prize pool can be provided by a third-party sponsor or advertiser.

According to some embodiments, the platform is configured to externally hide the wallet and/or contents of the wallet, from an external observer so that they cannot distinguish the transactions of an escrow account from other transactions on the blockchain). In some embodiments, this function can be implemented for the escrow wallet for the tournament, and/or the wallets for each user, as discussed above. In some embodiments, a wallet with cross-chain functionality may be utilized. In some embodiments, dynamic smart contracts can be utilized to determine specific conditions of escrow release.

According to some embodiments, the disclosed framework 300 can operate an escrow protocol backed by blockchain mechanisms by which funds are staked on-chain in accordance with smart contract terms and conditions for release which can be set by the user.

According to some embodiments, an organizer can set entry fee for each event, as well as set the “splits” for payouts (e.g., determine a share or how much first place, second place, and the like get per their seeding, results, popularity, and the like). In some embodiments, a max cap can be implemented to prevent abuse. In some embodiments, the cap can be set by the organizer prior to the tournament and/or can be dynamically applied upon detection of suspicious activity. In some embodiments, the framework (i.e., system) can generate a smart contract (or other type of secure data structure) that determines and/or records splits and wallet addresses. In some embodiments, ad revenue shares for organizers, competitors and/or publishers can be configured to be paid out according to preset criteria (e.g., in perpetuity).

In some embodiments, the amounts staked in a prize pool can be shown on a tournament page, and can be seen by all users (e.g., organizer, competitors and viewers).

In some embodiments, tournaments can be public, invite only public, or private. In some embodiments, tournaments that are public can be listed in a searchable database. In some embodiments, anyone can view or join a public tournament. In some embodiments, public tournaments may have a capped entry quota, so that only a predetermined number of users can join. In some embodiments, information related to pre-scheduled and/or upcoming tournaments can also be displayed on a tournament page, or a page associated with a website of the framework. In some embodiments, upcoming tournament information can include, but is not limited to, entry fee information, date, time, duration, projected prizes, sponsors, seeding of already registered users, and the like, or some combination thereof.

In some embodiments, different types of tournament can be created (e.g. single elimination, double elimination, round robin, and the like.) In some embodiments, some tournaments may have multiple matches depending on tournament type. In some embodiments, the framework can generate unique matches depending on event type.

In some embodiments, depending on tournament type, an organizer can place specific competitors into different brackets to compete. In some embodiments, for bracketed events, when each bracket finishes their individual matches, an organizer can select a winner of each bracket and then these winners can automatically be advanced into a next bracket, and the like, for example.

In some embodiments, upon the conclusion of a tournament, an organizer can note the winner(s), whereby results can then be provided for compliance analysis (e.g., a compliance team, or artificial intelligent (AI) and/or machine learning algorithm (e.g., computer vision, neural networks, and the like) to verify results. Once results are verified, a smart contract (e.g., or a similar type of secure data structure) can be used to unlock the escrow wallet or unbond tokens from the staking node of the tournament and release funds to the winner(s).

In some embodiments, game data can be recorded, monitored and analyzed live (or at the conclusion of a match), whereby a winner(s) can be determined.

In some embodiments, a future oracle token can be utilized for direct game integration. Therefore, in some embodiments, the future oracle token can be leveraged through direct integration with a game to determine verified match results. In some embodiments, therefore, the compliance step can be automated due to the security and accuracy of the future oracle token. In some embodiments, the token can be utilized to automate prize payouts to verified winners.

In some embodiments, publishers can integrate directly to the framework so that results and payouts can be automated.

In some embodiments, a tournament can comprise a plurality of unique video streams. As discussed above, a stream includes, but is not limited to, electronic data and metadata related to game play of the match. In some embodiments, an organizer can be provided a master stream, which can include information related to all matches. In some embodiments, the master stream can be for current matches being played; in some embodiments, the master stream can include on-demand features to recall and replay already played matches. Therefore, in some embodiments, as streams are compiled, streamed, downloaded and/or rendered over a network and/or hosted on a network resource, information related to the stream can be stored so that the results can be verified and/or so that users can render the streams on-demand.

In some embodiments, individual competitors can be provided individual streams. In some embodiments, such streams can include information related to, but not limited to, games each competitor is involved in or has played, competitors of the user, competitor statistics and the like.

In some embodiments, a tournament page can display all available streams. In some embodiments, the available streams can be organized and/or ranked according to a criterion that is based on, but is not limited to, scores, competitors, game length, popularity, and the like. In some embodiments, an organizer can select which streams are shown. In some embodiments, the displayed streams can be displayed as a gallery view. In some embodiments, an organizer can set a delay on stream to prevent streaming. For example, a 5-minute delay for strategy-based games to prevent teammates from looking at a competitor's screen to cheat).

In some embodiments, streams can be displayed as interactive objects that enable viewing users to select, enlarge, scrub, and search for specific actions, game play and/or actions performed during a streamed game.

In some embodiments, the framework 300 can be configured with functionality for switching (or toggling) randomly between videos of competitors on a master stream. In some embodiments, this can be dictated by a setting selected by an organizer that enables control of which streams are rendered to be selected automatically by the framework.

In some embodiments, the framework 300 enables viewers to tip (e.g., provide electronic funds to) competitors or organizers at any point during the tournament. In some embodiments, tips are automatically sent and go directly into the individual's wallet.

In some embodiments, the framework 300 can provide viewers with functionality to add to the prize pool by providing their own funds. In some embodiments, the entirety of the added funds goes directly into the tournament's wallet.

In some embodiments, users can follow/subscribe to specific organizers, competitors, and/or add a notification to be alerted when a specific scheduled tournament goes live, when a particular match is starting, and/or when a specific competitor is playing, and the like. In some embodiments, users can “friend” one another. In some embodiments, the framework 300 provides such users with the ability to privately message each other. In some embodiments, such messaging can be natively provided by messaging functionality of the mobile application; and in some embodiments, third party social and/or messaging applications can be utilized to facilitate such messaging.

According to some embodiments, tournaments can be geofenced. In some embodiments, such geofencing may be to limit or exclude certain types of users from competing and/or viewing a tournament. For example, some states do not allow gambling; therefore, such users may be prevented from entering as a competitor.

Process 700 begins with Step 702 where an online tournament is established. As discussed above, in some embodiments, a user can establish a tournament, and act as an organizer. Step 702 involves a user opening his/her mobile application (e.g., application 401) on his/her device, and provide input related to the generation of a tournament. The input includes information related to, but not limited to, a game(s), number of users, entry fee, geofencing information, number of rounds (or brackets), and the like, or some combination thereof.

As a result of the input provided by Step 702, a tournament can be established via execution of the tournament layer 407 (and, for example, tournament instance 408), as discussed above.

In some embodiments, Step 702 further involves generating and/or assigning a tournament page (e.g., tournament specific web page) within a website of the framework (or a set of network resources to host and/or facilitate tournament activities—for example, registration and/or game play). In some embodiments, messages can be compiled that include information about the tournament and mechanisms for users and/or viewers to register.

In Step 704, appropriate fees and entry information is collected from registering users. As mentioned above, users that can register are competitors and viewers. In some embodiments, the fees can be in a fiat form and/or crypto form, and can be associated with an entry fee, and the like, as discussed above. In some embodiments, the fees can be processed according to the components and functionality discussed above in relation to FIGS. 5A-6.

In some embodiments, the entry information can include information related to the registering user, such as, but not limited to, name, user name, location, IP address, wallet address, and the like.

In Step 706, the collected fees and information (from Step 704) are stored. In some embodiments, as discussed above, the fees can be stored in a tournament wallet (e.g., wallet 628, which can be identified as a wallet specific to a tournament (e.g., tournament service 406). In some embodiments, the fees and information can be stored according to the components and functionality discussed above in relation to FIGS. 4A-6—for example, for each user, user profile 627 can house the information for each registering user.

In Step 708, for each verified registered user, a token (e.g., Ignite or TENKA® token) can be purchased using cryptocurrency or fiat and assigned to the user. In some embodiments, as discussed above, the token is exchanged based on a conversion of the received entry fees. The token, which is proprietary to the disclosed framework, as discussed above, enables interaction with the services of the tournament—for example, a registered competitor can utilize the token to play in assigned matches, view other matches, traverse within the portal pages of the tournament, chat with other users, verify results, and ultimately receive prize payouts if applicable, and the like. Thus, the token can act as a user's key to navigate a tournament and interact with the services and functionality a tournament provides. In some embodiments, the token can be configured as an NFT that can legitimize a user's actions on and/or within a tournament, that can later be leveraged as a tangible asset, as understood with NFT functionality. For example, viewers may be able to bid on specific matches and/or gameplay of a user, and this can be provided via the user's token.

In some embodiments, when users enter tournaments, they will need to pay an entry fee. In some embodiments, this entry fee must be paid in TENKA® token and will be staked on-chain in a yield-farming prize pool generated for the tournament. In some embodiments, the platform will award additional TENKA® token rewards for all users who have staked the entry fee to participate in the tournament. In some embodiments, even if a user is eliminated from the tournament in an earlier round, their staked TENKA® token are entitled to participation rewards. In some embodiments, while users who are eliminated will lose the value of their initial TENKA® token stake at the end of the tournament, all users will receive pro rata the amount of new TENKA® token rewards awarded to the tournament, as a form of a participation reward/rebate.

In some embodiments, the system is configured to enable gamers to compete for an NFT which will be generated on-chain for every tournament. In some embodiments, gamers optionally may also compete for sponsored TENKA® token and sponsored NFTs. In some embodiments, once the compliance review has occurred, payouts will then be issued in TENKA® token to winner wallets. In some embodiments, the NFT prize will also be distributed once the compliance review has occurred. In some embodiments, an NFT includes a wearable NFT. In some embodiments, a wearable NFT includes a digital NFT asset in the form of a digital skin, digital item, or digital overlay. In some embodiments, non-limiting examples of wearable NFTs include jackets, pants, watches, potions, pills, weapons, glasses, and the like. In some embodiments, the system is configured to execute a reward when a wearable NFT is used and/or is being used. In some embodiments, non-limiting examples of rewards include increase in token farming power, reduction of fees, and/or free access to one or more tournament events.

In Step 710, the tournament is executed. The execution can involve, but is not limited to, streaming games, providing tournament pages, hosting matches, providing chat functionality, providing social functionality, awarding prizes, and the like, or some combination thereof, as discussed above. In some embodiments, progress, activity and updates to matches, users and a tournament can be provided via information in relation to a tournament's wallet, user's wallet, the issued tokens, and the like, or other information available to the tournament service 406, as discussed above. In some embodiments, advertisements can be provided on and/or within pages, screens, interfaces and/or rendered streams of a tournament, as discussed in more detail below in relation to Process 800 of FIG. 8.

In Step 712, results of a tournament are verified and payouts are processed, as discussed above according to some embodiments. In some embodiments, as discussed above, the results are verified and payouts are processed based on the oracle functionality provided by the gamers' tokens. In some embodiments, tokens can be paid out into any cryptocurrency or fiat currency from a single currency (e.g., Ignite/TENKA® token). In some embodiments, automatically determined winners can be identified and be paid in any cryptocurrency or fiat currency from a centralized prize pot (e.g., oracle automation). In some embodiments, the winning gamer/user can be paid in any format or denomination as requested.

By way of a non-limiting example, winners of first and second place are identified, their results can be confirmed by the compliance routines (e.g., analysis of the end of each tournament session), splits can be determined, and payouts processed. In some embodiments, the payouts can be provided in token form, then converted to fiat or to another crypto, as discussed above. In some embodiments, such processing involves tokenization, as discussed above. In some embodiments, the processing of payouts of Step 712 involves the access and modification of electronic information of a user's wallet, as discussed above.

FIG. 8 is a workflow process 800 for serving or providing related digital media content based on the information associated with a game or tournament, as discussed above in relation to at least FIGS. 4A-7. One example of a workflow process 800 is providing related digital content for display on a tournament page based on a championship match of a tournament. In some embodiments, the provided content can be associated with or comprising advertisements (e.g., digital advertisement content). Such information can be referred to as “game information” for reference purposes only.

In some embodiments, activity and achievements of each member (also referred to as a gamer or user) are measured via Gamer Points, visible on each Gamer digital ID (account; NFT). In some embodiments, Gamer Points have at least 2 purposes: (1) Seasonable leaderboard ranking—from season to season Ignite members will be invited to participate in global competitions in which those with the highest aggregated amount of Gaming Points will win additional rewards in TENKA® tokens and/or in-platform NFT wearables according to some embodiments. (2) Activity score—the average amount of Gaming Points accrued in last [n]—number of months will be used as an additional activity score measurement used to upgrade user Gamer ID level and subsequently increase received rewards and bonuses.

In some embodiments, in order to increase the level, tournament users will need to focus on strengthening their Staking Score and Activity Score. In some embodiments, the staking score is generated by liquidity providers, for their measured contributions during a specified time period. In some embodiments, the amount of a gamer's base TENKA® tokens will be multiplied for the purpose of staking score calculations. In some embodiments, activity score is similar to the staking score. In some embodiments, one difference is that it takes Gaming Points into account, which are earned by participating in tournaments on the platform. In some embodiments, the Activity Score is also used for the entire period of the ecosystem participant's activity from the moment they joined the network for the first time (as opposed to the time period used for staking score calculations.)

In some embodiments, tournament winnings are rewards for top places in each tournament organized via the tournaments platform, with the prize splits and number winners determined by the tournament organizer. In some embodiments, sponsored prizes also are included in tournament winnings by the system. In some embodiments, winning prizes are created from entry fees paid by each tournament participant. In some embodiments, these winnings are subjected to bonus multipliers connected with HODL and ACTIVITY levels, which affect the overall split of rewards.

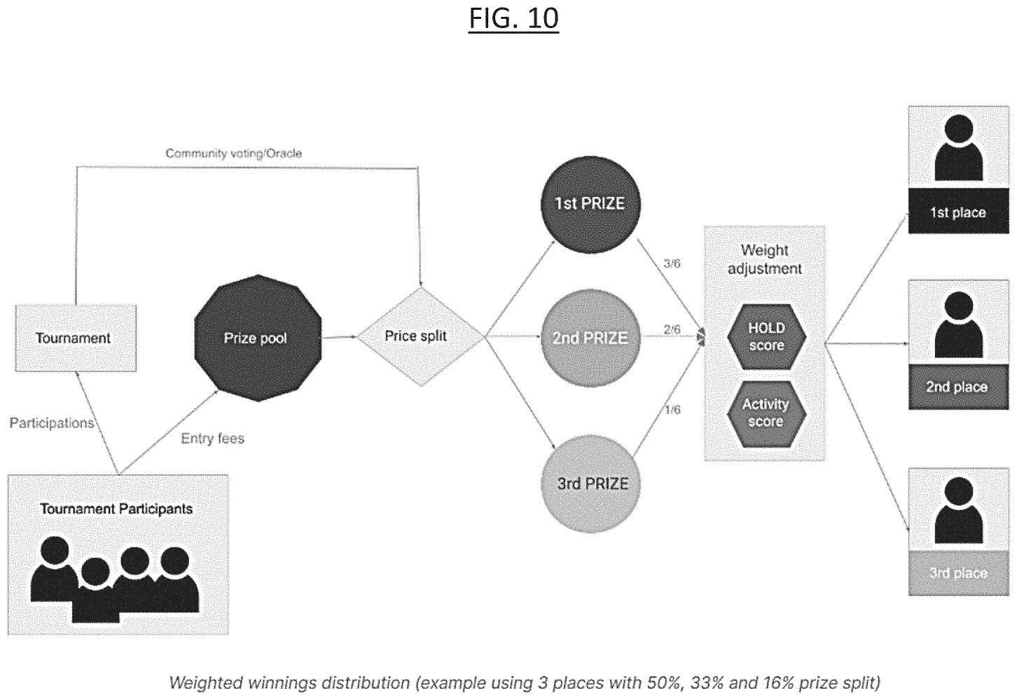

A non-limiting example is as follows: the tournament organizer decided that there will be 3 winning prizes, and their size will be determined by the following split of a prize pool: 1st place=prize pool*3/6, 2nd place=prize pool*2/6, 3rd place=prize pool*1/6. In some embodiments, such split is referred to as “primary split” and is subjected to secondary adjustment based on each winner's HODL and/or Activity level. FIG. 10 shows a weighted winnings distribution example using three places with 50%, 33% and 16% prize splits.

In some embodiments, applying weighted winnings splits might change the base proportions of the winnings per each place. In rare cases, the reward for a lower place might be higher than the reward for 2nd or 1st place according to some embodiments.

In some embodiments, the system is configured to enable a user to submit a proposal for a change in the system. In some embodiments, the system is configured to only allow a proposal after a deposit is made. In some embodiments, the deposit is in the form of one or more TENKA® tokens. In some embodiments, the system is configured to hold (i.e., prevent access) to the one or more TENKA® tokens until the proposal is accepted or rejected.

As discussed above, reference to an “advertisement” should be understood to include, but not be limited to, digital media content that provides information provided by another user, service, publisher, sponsor, third party, entity, and the like. Such digital ad content can include any type of known or to be known media renderable by a computing device, including, but not limited to, video, text, audio, images, and/or any other type of known or to be known multimedia according to some embodiments. In some embodiments, the digital ad content can be formatted as hyperlinked multimedia content that provides deep-linking features and/or capabilities. Therefore, while the content is referred to as an advertisement, in some embodiments, it is still a digital media item that is renderable by a computing device, and such digital media item comprises digital content relaying promotional content provided by a network associated with a third party.

In Step 802, game information is identified. This information can be derived, determined, based on or otherwise identified from the steps of Process 700, as discussed above. For example, game information can refer to a type of tournament, as well as a location of a competitor playing in a currently live match stream. In another example, the game information can be based on, either additionally or alternatively, on a viewer.

For purposes of this disclosure, Process 800 will refer to a game(s) of a single tournament; however, it should not be construed as limiting, as any number of games, competitors, tournaments, and the like, can form such basis, without departing from the scope of the present disclosure.

In Step 804, a context is determined based on the identified game information. This context forms a basis for serving content related to the content information. For example, a stream of a match between two competitors playing Fortnite® is displayed on a tournament page, and viewer Bob, who resides in Salt Lake City, Utah, is watching. Thus, in this example, a context can be “Fortnite®” and “SLC” (short-hand for Salt Lake City).

In some embodiments, the identification of the context from Step 804 can occur before, during and/or after a game is played and/or the results are compiled for a game and/or tournament, or it can be a separate process altogether, or some combination thereof.

In Step 806, the determined context is communicated (or shared) with a content providing platform comprising a server and database (e.g., content server 106 and content database 107, and/or advertisement server 130 and ad database). In some embodiments, upon receipt of the context, the server performs (e.g., is caused to perform as per instructions received from the device executing the engine 300) a search for a relevant digital content within the associated database. In some embodiments, the search for the content is based at least on the identified context.

In Step 808, in some embodiments, the server searches the database for a digital content item(s) that matches the identified context. In Step 810, a content item is selected (or retrieved) based on the results of Step 808 according to some embodiments.

For example, based on the context: “Fortnite®” and “SLC”; the content item can be a digital advertisement or coupon for a game shop close in geographic proximity to Bob, where the coupon provides a discount for an Xbox One®.

In some embodiments, the selected content item can be modified to conform to attributes or capabilities of a device, browser user interface (UI), stream, page, interface, platform, or application upon which a user will be viewing a tournament. In some embodiments, the selected content item is shared or communicated via the application or browser the user is utilizing to view and/or play in a tournament. At Step 812, in some embodiments, the selected content item is sent directly to a user computing device for display on a device and/or within a user interface (UI) displayed on the device's display (e.g., within the browser window and/or within an inbox of a high-security property). In some embodiments, the selected content item is displayed within a portion of the stream, tournament page, interface or within an overlaying or pop-up interface associated with a rendering interface displayed on the device.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of the system implemented steps presented and described as flowcharts in this disclosure are provided by way of example in order to provide a more complete understanding of the technology. The disclosed steps are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure. It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Any text in the drawings are part of the system's disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. Any figure depicting a content for display on a graphical user interface is a disclosure of the system configured to generate the graphical user interface and configured to display the contents of the graphical user interface. It is understood that defining the metes and bounds of the system using a description of images in the drawing does not need a corresponding text description in the written specification to fall with the scope of the disclosure.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured.

“Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

As used herein, “can” or “may” or derivations there of (e.g., the system display can show X) are used for descriptive purposes only and is understood to be synonymous and/or interchangeable with “configured to” (e.g., the computer is configured to execute instructions X) when defining the metes and bounds of the system. The phrase “configured to” also denotes the step of configuring a structure or computer to execute a function in some embodiments.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited. Another example is “a computer system configured to or programmed to execute a series of instructions X, Y, and Z.” In this example, the instructions must be present on a non-transitory computer readable medium such that the computer system is “configured to” and/or “programmed to” execute the recited instructions: “configure to” and/or “programmed to” excludes art teaching computer systems with non-transitory computer readable media merely “capable of” having the recited instructions stored thereon but have no teachings of the instructions X, Y, and Z programmed and stored thereon. The recitation “configured to” can also be interpreted as synonymous with operatively connected when used in conjunction with physical structures.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the invention are useful machine operations. The invention also relates to a device or an apparatus for performing these operations. All flowcharts presented herein represent computer implemented steps and/or are visual representations of algorithms implemented by the system. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g. a cloud of computing resources.

The embodiments of the invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations are presented in a specific order according to some embodiments, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

We claim:

1. A system for electronic gaming comprising:
one or more computers comprising one or more processors and one or more non-transitory computer readable media, the one or more non-transitory computer readable media comprising instructions stored thereon that, when executed, cause the one or more computers to implement steps that include:
generating, by the one or more processors, a gaming framework;
receiving, by the one or more processors, a request to create an electronic game;
enabling, by the one or more processors, access to registration for the electronic game, the access enabling a user to register electronically over a network;
collecting, by the one or more processors, entry information from a set of users, the entry information comprising electronic fund information and registration information;
associating, by the one or more processors, the collected entry information with a gaming ID;
issuing, by the one or more processors, one or more digital tokens to the user in exchange for cryptocurrency and/or fiat currency, wherein possession of at least one of the one or more digital tokens is required to participate in the electronic game.

2. The system of claim 1,
wherein the one or more non-transitory computer readable media comprises further instructions stored thereon that when executed cause the one or more computers to implement steps that include:
electronically hosting, over the network, matches of the electronic game, wherein hosting enables each of the set of users to play assigned matches and/or view other matches via streams of each match, wherein results of each match are compiled in relation to participating users of a respective match.

3. The system of claim 2,
wherein the one or more non-transitory computer readable media comprises further instructions stored thereon that when executed cause the one or more computers to implement steps that include:
determining, based on analysis of the matches, a winning user of the electronic game; and
executing, by the one or more processors, a payout for the winning user, the payout comprising electronically transferring one or more of the one or more digital tokens from a digital wallet associated with the tournament to a digital wallet of the winning user.

4. The system of claim 1,
wherein possession of the one or more digital tokens by a user enables one or more of engagement in a tournament, verification of results within the tournament, and reception of prizes, and/or advertisement revenue sharing.

5. The system of claim 1,
wherein the one or more digital tokens operate as a governance token.

6. The system of claim 5,
wherein the governance token provides voting rights to vote on one or more of rewards allocation, risk management, network upgrades, treasury management, council membership elections, and rates.

7. The system of claim 1,
wherein the gaming framework is configured to enable the one or more digital tokens to be traded, bought, and/or sold.

8. The system of claim 1,
wherein the gaming framework is configured to enable the one or more digital tokens to be obtained by farming.

9. The system of claim 7,
wherein farming includes using a gamer's computer to execute algorithms associated with a blockchain technology.

10. The system of claim 1,
wherein the gaming framework includes an escrow protocol backed by a blockchain in accordance with smart contract terms.

11. The system of claim 1,
wherein the one or more non-transitory computer readable media comprises further instructions stored thereon that, when executed, cause the one or more computers to implement steps that include:
associating, by the one or more processors, gamer points with the gaming ID;
wherein the system is configured to apply a multiple to winning based on the gamer points.

12. The system of claim 1,
wherein the one or more non-transitory computer readable media comprises further instructions stored thereon that when executed cause the one or more computers to implement steps that include:
generating, by the one or more processors, a proposal for a change in the gaming framework.

13. The system of claim 12,
wherein the proposal can only be submitted upon completion of a deposit.

14. The system of claim 13,
wherein the system is configured to hold the deposit until the proposal is accepted or rejected.

15. The system of claim 13,
wherein the deposit must be in the form of the one or more digital tokens.
